(19) United States
(12) Patent Application Publication
(10) Pub. No.: US 2026/0155432 A1
(43) Pub. Date: Jun. 4, 2026

(54) SOLID-STATE BATTERY, COMPOSITE POLYMER ELECTROLYTE, AND METHOD

(71) Applicant: Purdue Research Foundation, West Lafayette, IN (US)

(72) Inventors: Esteban Ernesto Marinero-Caceres, West Lafayette, IN (US); Praveen Balaji Thamarai Kannan, West Lafayette, IN (US)

(21) Appl. No.: 19/407,398

(22) Filed: Dec. 3, 2025

Related U.S. Application Data
(60) Provisional application No. 63/727,646, filed on Dec. 3, 2024.

(51) Int. Cl. H01M 10/056; H01M 10/0525

(52) U.S. Cl. CPC H01M 10/056; H01M 10/0525; H01M 2300/0071; H01M 2300/0082; H01M 2300/0091

(57) ABSTRACT

Solid-state batteries, composite polymer electrolytes, and methods associated therewith. Such a composite polymer electrolyte includes high-entropy oxide particles and anion salt mixed in an amorphous polymer matrix. The polymer matrix may be made from a blend of a flexible, high melting point amorphous polymer, such as epoxidized natural rubber, and a semicrystalline polymer, such as polyethylene oxide. The solid-state battery may be a lithium-ion battery incorporating the composite polymer electrolyte with LiTFSI as the anion salt. The loading of the high-entropy oxide particles in the polymer matrix can be adjusted to adjust the ion conductivity of the composite polymer electrolyte.

### CROSS-REFERENCE TO RELATED APPLICATIONS

This application claims the benefit of provisional U.S. Patent Application No. 63/727,646 filed Dec. 3, 2024, the contents of which are incorporated herein by reference.

### BACKGROUND OF THE INVENTION

The invention relates generally to solid-state batteries, composite polymer electrolytes therefor, and related methods.

Lithium-ion batteries (LIBs) are currently the predominant batteries available in the market. However, their safety and reliability can be hindered by the use of flammable liquid electrolytes. The flammability and chemical reactivity of conventional lithium-ion batteries is accelerated at high temperatures, thereby limiting the high temperature range for safe and reliable operation of batteries. For example, some typical current specifications for LIBs for electric vehicles are an optimal operating range of 15° C. to 35° C. However, utilization above 45° C. results in accelerated materials and performance degradation that can ultimately result in catastrophic failure and explosions. There is a need in the commercial and defense markets for rechargeable batteries that can safely and reliably operate at higher temperature applications (e.g., above 45° C.).

Composite polymer electrolytes (CPEs) are leading candidates to replace current liquid electrolytes in electrical energy storage devices, such as batteries, to solve the safety issues, the limitations in energy capacity and cyclability limitations of current lithium ion batteries using flammable liquid electrolytes and to enable the implementation of earth abundant cathode materials such as S, and metal anodes (e.g., Li, Mg, Ca) to drastically increase the gravimetric and volumetric capacity of batteries. Composite polymer electrolytes integrate a polymer and anion-salt matrix with inorganic fillers to enhance by orders of magnitude the ionic conductivity of the polymer matrix. In one known composite polymer electrolyte disclosed in US20220238907A1, LiLaZrBiO particles are added to a polymer matrix made of polyethylene oxide (PEO) and the anion salt lithium bis(trifluoromethanesulfonyl)imide (LiTFSI). This resulted in ionic conductivity enhancements of the polymer-LiTFSI matrix by orders of magnitude.

Polyethylene oxide is one of the most extensively utilized polymers in CPEs on account of its ability to dissolve numerous anion salts, and its molecular structure includes multiple negatively charged oxygen-ether groups that provide sites in the polymer chain for the Li+ cations to weakly bind. PEO is a semicrystalline polymer whose crystalline fraction, typically ranging from 50% to 80%, depends on molecular weight, processing conditions and thermal history. However, a significant limitation for the utilization of PEO for battery applications is its low melting point, which depends on its molecular weight and typically ranges from about 65° C. to 70° C. Near its melting point, PEO undergoes significant transformations in mechanical rigidity, becoming a viscous liquid, as well as its thermal and chemical stability, all of which can lead to thermal degradation, potentially resulting in battery failure.

Batteries for high-temperature environments must withstand extreme thermal conditions without degradation in performance, safety, or lifespan. However, without cooling systems, the internal temperature of the battery compartment of an electric vehicle in extreme hot climates can often exceed ambient temperatures, potentially exceeding 70° C. Therefore, the use of PEO as the polymer matrix for a solid-state polymer electrolyte may result in its degradation and potential failure.

In theory, these high-temperature limitations could be addressed by using an amorphous polymer material with a higher melting temperature and a low glass transition temperature. For example, polymers such as epoxidized natural rubber (ENR), an amorphous material with a melting point in the vicinity of 200° C. and a glass transition temperature around −50° C. would theoretically be ideal for CPEs in high temperature applications due to its amorphous nature and low glass transition temperature (the temperature at which the polymer transitions from a rigid or glassy state to a more flexible state). However, pure ENR, as well as other amorphous flexible, high melting point (e.g., above about 190° C.) polymers such as polyimide (melt temp. 400° C.), polyetherimide (melt temp. 217° C.), polyethersulfone (melt temp. 225° C.), and others, have no inherent ionic conductivity and are unable to dissolve anion salts as effectively as PEO, which renders them inadequate for their use as polymer electrolytes on their own.

Therefore, it would be desirable to have a solid-state composite electrolyte with a relatively high melting temperature to improve high-temperature stability, a relatively low glass transition temperature to maintain suitable physical flexibility, that can also provide suitable ionic conductivity for use in typical battery applications, such as in electric vehicles.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, solid-state batteries, composite polymer electrolytes for solid-state batteries, and methods of making the composite polymer electrolytes.

According to a nonlimiting aspect, a composite polymer electrolyte for a solid-state battery includes a flexible, amorphous polymer matrix having a melting temperature above about 100° C., an anion salt dispersed in the polymer matrix, and high-entropy oxide particles dispersed in the polymer matrix.

According to another nonlimiting aspect, a solid-state battery includes an anode, a cathode, and the composite polymer electrolyte described above operatively disposed between the anode and the cathode to facilitate ion transfer from one of the anode and the cathode to the other of the anode and the cathode.

According to yet another nonlimiting aspect, a method of making the composite polymer electrolyte is provided. The method includes mixing together the amorphous polymer, the semicrystalline polymer, the anion salt, the high-entropy oxide particles, and a solvent to form a homogeneous slurry. The slurry may then be formed into a desired shape, the formed slurry dried, and the solvent removed to form the composite polymer electrolyte.

Technical aspects of composite polymer electrolytes as described above preferably include the ability to provide solid-state lithium-ion batteries with improved safety and/or functionality in higher-temperature use environments.

These and other aspects, arrangements, features, and/or technical effects will become apparent upon detailed inspection of the figures and the following description.

### BRIEF DESCRIPTION OF THE DRAWINGS

FIG. 1 is a schematic diagram of a solid-state battery exemplifying some nonlimiting aspects of the invention.

FIG. 2 is a process diagram of method of making a composite polymer electrolyte exemplifying some nonlimiting aspects of the invention.

FIG. 3 is a schematic illustration of another process flow for fabricating test samples of composite electrolytes made of an ENR/PEO blend with LiTFSI anion salt and (MgCoNiCuZn)O high entropy oxide nanoparticles exemplifying some nonlimiting aspects of the invention.

FIG. 4 is a graph showing temperature-dependent measurements of ionic conductivity versus % wt. load of HEO nanoparticles of various test samples of some composite polymer electrolytes exemplifying some nonlimiting aspects of the invention and a control sample.

FIG. 5 is a graph showing correlations between different HEO loadings and activation energy of the various test samples.

### DETAILED DESCRIPTION OF THE INVENTION

The intended purpose of the following detailed description of the invention and the phraseology and terminology employed therein is to describe one or more nonlimiting embodiments of the invention, and to describe certain but not all aspects of what is depicted in the drawings, including the embodiment(s) to which the drawings relate. The following detailed description also describes certain investigations relating to the embodiment(s) and identifies certain but not all alternatives of the embodiment(s). As nonlimiting examples, the invention encompasses additional or alternative embodiments in which one or more features or aspects shown and/or described as part of a particular embodiment could be eliminated and also encompasses additional or alternative embodiments that combine two or more features or aspects shown and/or described as part of different embodiments. Therefore, the appended claims, and not the detailed description, are intended to particularly point out subject matter regarded to be aspects of the invention, including certain but not necessarily all of the aspects and alternatives described in the detailed description.

As used herein the terms “a” and “an” to introduce a feature are used as open-ended, inclusive terms to refer to at least one, or one or more of the features, and are not limited to only one such feature unless otherwise expressly indicated. Similarly, use of the term “the” in reference to a feature previously introduced using the term “a” or “an” does not thereafter limit the feature to only a single instance of such feature unless otherwise expressly indicated.

The present application discloses solid-state polymer electrolytes made with one or more amorphous polymer materials having high melting points and low glass transition temperatures that can efficiently dissolve anion salts to increment their ionic conductivity by orders of magnitude, while preserving their inherent flexibility and high temperature stability. Because of the high melting points, these solid-state polymer electrolytes are believed to be particularly suitable for high temperature batteries. The products and methods disclosed can, in some arrangements, provide a solution to the inability of amorphous polymers to dissolve anion salts for applications in solid-state electrolytes for energy storage. In some arrangements, this is achieved through the addition of high-entropy oxide nanoparticles with ultrahigh dielectric constants.

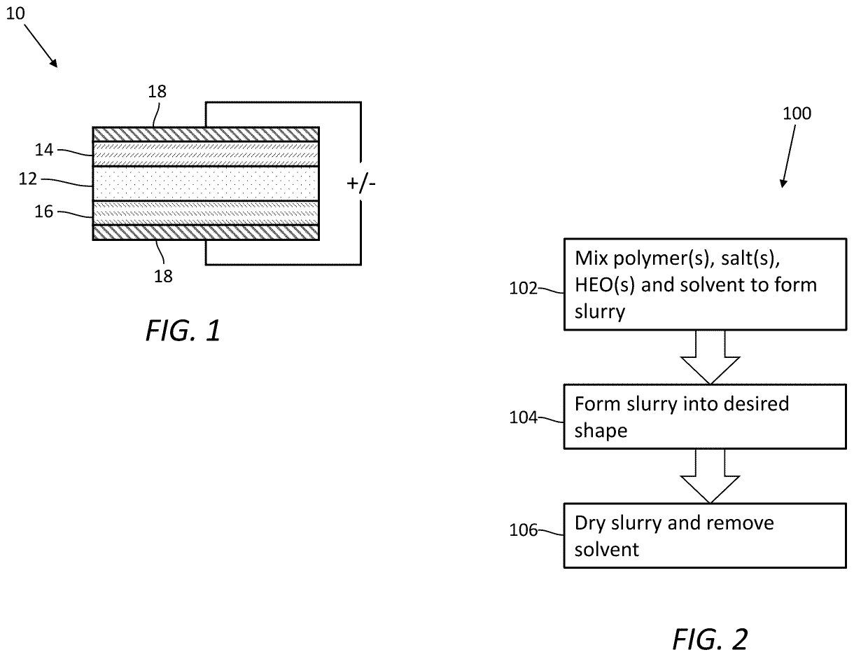

Turning now to the nonlimiting embodiments represented in the drawings, FIG. 1 depicts a solid-state battery 10 having a composite polymer electrolyte 12 operatively disposed between an anode 14 and a cathode 16 to facilitate ion transfer back and/or forth from one of the anode and the cathode to the other of the anode and the cathode. In this example, the composite polymer electrolyte 12 may be provided in the form of a relatively flat sheet or thin film sandwiched between and against the anode 14 and the cathode 16 such that the anode engages one side of the electrolyte sheet/film and the cathode engages the other, opposite side of the electrolyte sheet/film. However, other morphologies and configurations are also possible. The ion transfer may be reversable in some configurations, such as in a rechargeable battery configuration. The battery 10 may be, for example, a rechargeable lithium-ion battery having a lithium metal cathode 16. The anode 14 may be any suitable anode material, such as copper. In other configurations the battery may be another type of ion-exchange battery with different types of anode or cathode materials. The battery 10 may also include other components, such as electrical contacts 18 electrically coupled with the respective anode 14 and cathode 12, an outer shell, and any other suitable components for the battery's intended usage.

The composite polymer electrolyte 12 is made of an amorphous polymer matrix with an anion salt and a filler of high-entropy oxide (HEO) particles dispersed throughout the matrix. The anion salt 22 and the HEO filler particles may be dispersed substantially homogeneously throughout the polymer matrix to promote reasonably even ion transfer across the thickness of the electrolyte sheet 12. An effective amount of the HEO particles is used to increase the ionic conductivity of the amorphous polymer matrix, which, without the HEO particles, is typically too low for practical application as an electrolyte matrix for a battery. The composite polymer electrolyte 12 preferably has a melt temperature higher than the expected highest running temperature of the battery in which it will be utilized. For example, the melt temperature of the composite polymer electrolyte 12 is preferably above at least about 75-80° C., and more preferably above about 100° C. or higher. In addition, the composite polymer electrolyte 12 preferably has a glass transition temperature low enough to be in a glass phase under most typical weather conditions, such as below about 0° C. or lower. In some nonlimiting embodiments, the composite polymer electrolyte 12 has a glass transition temperature of about −10° C. to about −15° C. and a melt temperature of about 135° C. and 145° C.

The amorphous polymer matrix maybe made of two or more different types of polymers. For example, the amorphous polymer matrix may be made with a blend of at least one flexible, high melting point amorphous polymer and a semicrystalline polymer. In some arrangements, the amorphous polymer matrix is formed from a blend of the flexible, high melting point amorphous polymer epoxidized natural rubber (ENR) and polyethylene oxide (PEO). The PEO may have a melt temperature of about 66-70° C., a glass transition temperature of about −54° C., and a tensile strength of about 14 MPa. The ENR may have a melt temperature of about 190° C., a glass transition temperature of about −20° C., and a tensile strength of about 20 MPa. In other embodiments, different and/or additional flexible, high melting point polymers, such as polyimide, polyetherimide, and/or polyethersulfone, could be used in the blend. In some embodiments of the ENR/PEO blend, the ENR enhances or fully amorphizes the PEO. The dispersion of the ENR in the PEO can also lower the glass transition temperature of the blend. In addition, the ENR provides enhanced elasticity relative to the PEO, which contributes to the ability to produce thin and flexible solid-state electrolytes. The enhanced elasticity can provide superior contact between the polymer electrolyte and the battery electrodes, which in some cases can help prevent interface delamination caused by volume expansion of anode and cathodes during charge/discharge battery cycles and/or reduce interface ionic resistance.

The anion salt may be any ion-producing salt that operates to transfer ions back and/or forth between the anode 14 and a cathode 16 of the battery 10. Preferably, the molecular structure of the anion salt includes cations that, upon dissociation of the salt, contribute to free ions and enhanced ionic conductivity. This includes, but is not restricted to, LiTFSI for the case of lithium-ion batteries. For example, the battery 10 may be a lithium-ion battery with a lithium cathode, and the anion salt may be a lithium-based salt, such as lithium bis(trifluoromethanesulfonyl)imide (LiTFSI) or another lithium salt suitable for the ion transfer. However, it is understood that other salts could be used for other types of batteries.

The high-entropy oxides forming the high-entropy oxide particles are multicomponent oxides formed of five or more cations in substantially equimolar ratios. A particular high-entropy oxide is (MgCoNiCuZn)O. A non-exhaustive list of other typical high-entropy oxides that may be used include ((CoCrFeMnNi)O4, (CrMnFeCoNiCuZn)O4, and Sr(ZrSnTiHfMn)O3. The high-entropy oxide may have various crystalline structures, such as rock salt, spinel, and perovskite, although other crystalline structures are possible. In one nonlimiting embodiment, the high-entropy oxide particles are made of (MgCoNiCuZn)O, which has a rock salt crystalline structure, and may be at nano-scale (i.e. about 1-999 nm diameter). For example, in one nonlimiting example, the high-energy oxide particles are nanoparticles having an average diameter of about 900 nm, although larger and/or smaller average particle sizes could be implemented. The high-entropy oxide particles may be formed in any suitable manner. The HEO filler particles are believed to change the polarity of the ENR/PEO polymer matrix. In addition, varying the wt % load of MgCoNiCuZn)O nanoparticles in ENR/PEO blends containing the anion salt LiTFSI also correspondingly varies the ability of the blend to dissolve the anion salt. In some cases, this can result in a solid-state composite polymer electrolyte that at high temperatures rivals the ionic conductivity of current liquid electrolytes.

While any effective amount of the HEO particles helps improve the ionic conductivity of the composite polymer electrolyte 12, investigations conducted in the course of developing this electrolyte show that, in an amorphous polymer matrix formed of epoxidized natural rubber and polyethylene oxide, at around 10 wt % loading (% by weight of the composite polymer electrolyte) of high-entropy oxide particles made of (MgCoNiCuZn)O, the rate of decrease in ion transport activation energy obtained from increasing the loading of the high-entropy oxide slows dramatically. In other words, with increasing loading of the HEO particles up to about 10 wt %, there is a relatively rapid corresponding increase of the ion conductivity, however, above about the 10 wt % loading the increase in ion conductivity becomes markedly less rapid. Therefore, it appears that about a 10 wt % loading may be, at least in some arrangements, a good balance between obtaining improved ion conductivity and diminishing returns above this loading.

Turning to FIG. 2, a nonlimiting example method 100 for fabricating the composite polymer electrolyte 12 includes at 102 mixing the mixing the polymer(s), salt(s), HEO particles(s) and a solvent to form a substantially homogeneous slurry. The mixing may be accomplished in multiple stages or may be accomplished in a single mixing stage. For example, in a multi-stage mixing, the polymers may be mixed with one or more solvents separately and subsequently mixed together to form a blended multi-polymer matrix, and the anion salt(s) and the HEO particles may be mixed into the blended multi-polymer matrix until the salts and HEO particles are thoroughly mixed throughout the polymer matrix such that the slurry is a substantially homogeneous mixture of all the constituent ingredients.

At 104, once the slurry has been sufficiently formed, the slurry may then be formed into any suitable shape and/or form desired. For example, the slurry may be formed into a thin sheet morphology suitable for use as an electrolyte sheet as disused earlier. One suitable forming method is by casting the slurry onto a flat casting surface to form a sheet/film morphology. While the morphology of a sheet may be formed, it is understood that further shaping and/or sizing may subsequently be done, for example, to cut the resulting sheet/film into a desired shape. However, the slurry may be formed into various other shapes as appropriate and/or desired for a given end use. As discussed elsewhere herein, the ionic conductivity of the resulting amorphous polymer may be increased by increasing the amount of the high-entropy oxide particles mixed into the slurry.

At 106, the slurry is then dried, and the solvent is removed from the slurry to leave just the polymer(s), salt(s), and HEO particles(s) in a solid, yet suitably elastic, flexible state for subsequent use as the solid-state composite polymer electrolyte 10. The solvent may be removed simultaneously as the slurry is dried, for example by drying the slurry at elevated temperature in an oven while also under a vacuum to draw off all the solvent. The flexibility and elasticity of the resulting dried is well suited for allowing the electrolyte 10 to conform to various shapes, thereby ensuring good contact between the solid-state polymer electrolyte 10 and the anode 14 and cathode 15.

### Example Investigations

Next, some theory and practical investigations leading to the development of the present invention(s) are described to provide some nonlimiting representative examples and proofs of concepts. It is understood that these examples are not exhaustive of all the aspects of the present invention(s).

The high-entropy oxides (MgCoNiCuZn)O were synthesized following the sol-gel procedure described by Mnasri et al., “Synthesis of (MgCoNiCuZn)O entropy-stabilized oxides using solution-based routes: influence of composition on phase stability and functional properties,” J. Mater. Chem. C, 9(42), 15121, 2021, the contents of which are incorporated by reference herein. The HEO was processed into a powder form of nanoparticles having crystalline structures.

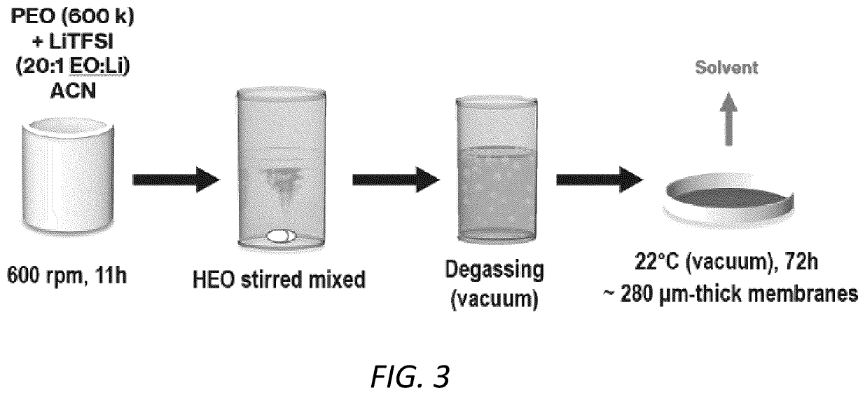

With reference to FIG. 3, the polymer electrolyte membranes were fabricated by dissolving the appropriate quantity of PEO powder and ENR50 in Tetrahydrofuran (THF) solvent and stirring the mixture thoroughly. Subsequently, the two solutions were combined and stirred continuously until the mixture achieved homogeneity. The resultant homogeneous solution was then ball milled with 20 wt. % of LiTFSI together with various % wt. loads of HEO for 4 hours. Test samples were made with HEO loads of 0% (as a control sample), 2%, 4%, 6%, 8%, 10%, 12%, 14%, and 16% (wt %). The resulting slurries were poured onto Teflon molds and dried in a vacuum oven at 55° C., for 24 hours at a pressure of 0.2 bar to completely remove the solvent and form dried polymer films. The dried polymer films were then stored in an inert atmosphere. All the samples were re-dried in a vacuum oven at 50° C. approximately 48 hours prior to fabrication of solid-state electrolyte specimens for ion transport measurements and spectroscopic characterization.

Various characteristics of the composite polymer electrolyte specimens from each test sample were then measured and/or calculated, including the ionic conductivity, dielectric constants, and thermal properties. In addition, the effect of the various HEO nanoparticle additions to improve the ability of the ENR/PEO blends to dissolve the LiTFSI anion salt was also investigated. Table 1 below lists the glass transition temperature, melt temperature, and Xc for each of the test samples.

TABLE 1
glass transition temperature (Tg), melt temperature (Tm), and Xc

| HEO loadings | | | |
|---|---|---|---|
| (wt %) | Tg (° C.) | Tm(° C.) | Xc |
| 0 | −10.26 | 144.24 | 59.15 |
| 2 | −10.87 | 142.03 | 43.04 |
| 4 | −11.18 | 141.77 | 41.46 |
| 6 | −12.08 | 141.18 | 39.60 |
| 8 | −12.11 | 140.13 | 33.44 |
| 10 | −12.79 | 139.92 | 27.61 |
| 12 | −12.96 | 139.36 | 23.75 |
| 16 | −13.95 | 138.05 | 19.37 |

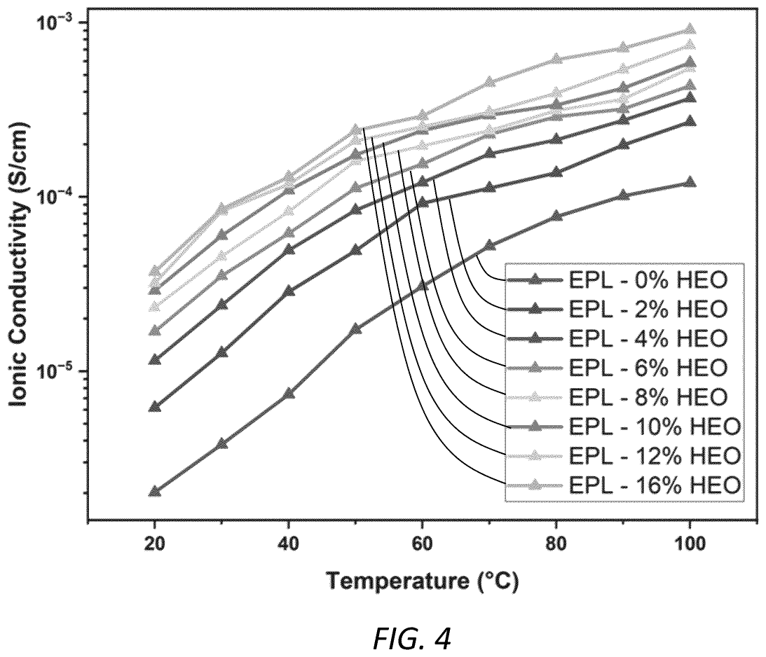

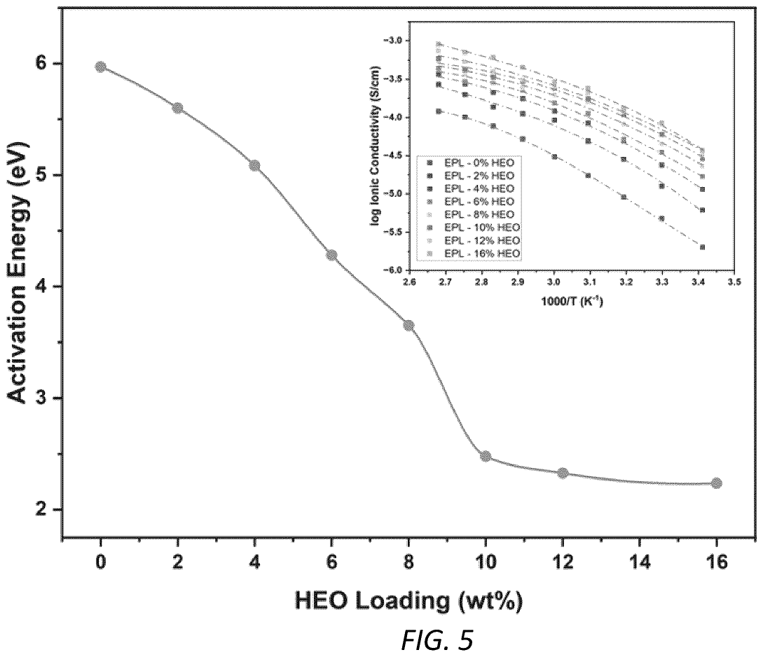

FIG. 4 shows a graph of the ionic conductivity of the test samples loaded with the increasing % wt. loads of the HEO nanoparticles versus temperature. These results show a significant increment of the ionic conductivity as a function of % wt. load of HEOs in the ENR/PEO/LiTFSI membranes for all temperatures investigated. FIG. 5 shows a graph of the ion transport activation energies of the various samples versus HEO % wt. load as derived from Arrhenius plots (shown in the insert). These results show a significant reduction of the activation energy versus the HEO particle % wt. load from 5.97 eV (575.98 kJ/mol) for the EPL without HEO (i.e., 0% HEO load) to 2.24 eV (215.76 kJ/mol) when the HEO particle wt. load is 16%. It can also be seen that at around 10 wt % HEO loading, the rate of change (decrease) in the activation energy versus increased HEO loading slows dramatically, such that, above about the 10 wt % loading, the incremental increase in ion conductivity obtained by adding more of the HEO becomes markedly less. The investigations also showed that the increasing the load of the HEO nanoparticles in the polymer-anion salt matrix enhances the polarity of the polymer matrix and its ability to dissolve and disassociate salts, which is believed to lead to the corresponding increases in the ionic conductivity of the amorphous polymers that, without the HEO nanoparticles would otherwise not exhibit ionic conductivity suitable for battery applications.

The solid-state polymer electrolytes disclosed herein are believed to provide a solution to the inability of many high melt temperature amorphous polymers to dissolve anion salts for applications in solid-state electrolytes for energy storage, particularly in batteries for use in higher-temperature environments, such as in electric vehicles. Without wishing to be held to theory, additional applications for using the solid-state polymer electrolytes disclosed herein are believed to include uses in capacitors, improving electronic component performance, enabling more compact electronic devices, improving ferroelectric behavior, improving spontaneous polarization and switchability, and/or improving sensor speeds and response times.

As previously noted above, though the foregoing detailed description describes certain aspects of one or more particular embodiments of the invention, alternatives could be adopted by one skilled in the art. For example, the composite polymer electrolytes, solid-state batteries, and their components could differ in appearance and construction from the embodiments described herein and shown in the drawings, functions of certain components of the composite polymer electrolytes and solid-state batteries could be performed by components of different construction but capable of a similar (though not necessarily equivalent) function, and various materials could be used in the fabrication of the composite polymer electrolytes, solid-state batteries, and/or their components. As such, and again as was previously noted, it should be understood that the invention is not necessarily limited to any particular embodiment described herein or illustrated in the drawings.

1. A composite polymer electrolyte for a solid-state battery, the composite polymer electrolyte comprising:
a flexible, amorphous polymer matrix having a melting temperature above about 100° C.;
an anion salt dispersed in the polymer matrix; and
high-entropy oxide particles dispersed in the polymer matrix.

2. The composite polymer electrolyte of claim 1, wherein the high-entropy oxide particles are a multicomponent oxide formed of five or more cations in substantially equimolar ratios.

3. The composite polymer electrolyte of claim 2, wherein the high-entropy oxide particles have a crystalline structure of at least one of rock salt, spinel, and perovskite.

4. The composite polymer electrolyte of claim 3, wherein the high-entropy oxide particles comprise at least one of (MgCoNiCuZn)O, (CoCrFeMnNi)O4, (CrMnFeCoNiCuZn)O4, and Sr(ZrSnTiHfMn)O3.

5. The composite polymer electrolyte of claim 2, wherein the high-entropy oxide particles are (MgCoNiCuZn)O.

6. The composite polymer electrolyte of claim 5, wherein the (MgCoNiCuZn)O comprises at least 10 wt % of the composite polymer electrolyte.

7. The composite polymer electrolyte of claim 5, wherein the high-energy oxide particles are nanoparticles.

8. The composite polymer electrolyte of claim 7, wherein the nanoparticles have an average diameter of about 900 nm.

9. The composite polymer electrolyte of claim 1, wherein the anion salt is a lithium salt.

10. The composite polymer electrolyte of claim 9, wherein the lithium salt is lithium bis(trifluoromethanesulfonyl)imide.

11. The composite polymer electrolyte of claim 1, wherein the amorphous polymer matrix comprises a blend of an amorphous polymer and a semicrystalline polymer.

12. The composite polymer electrolyte of claim 11, wherein the amorphous polymer comprises epoxidized natural rubber.

13. The composite polymer electrolyte of claim 12, wherein the semicrystalline polymer comprises polyethylene oxide.

14. The composite polymer electrolyte of claim 1, wherein the composite polymer electrolyte has a glass transition temperature of about −10° C. to about −15° C. and a melt temperature of about 135° C. and 145° C.

15. A solid-state battery comprising:
an anode;
a cathode; and
the composite polymer electrolyte of claim 1 operatively disposed between the anode and the cathode to facilitate ion transfer from one of the anode and the cathode to the other of the anode and the cathode.

16. The solid-state battery of claim 15, wherein the anode is a lithium metal anode.

17. A method of making the composite polymer electrolyte of claim 1, the method comprising:
mixing together the amorphous polymer, the semicrystalline polymer, the anion salt, the high-entropy oxide particles, and a solvent to form a homogeneous slurry;
forming the slurry into a desired shape; and
drying the formed slurry and removing the solvent to form the composite polymer electrolyte.

18. The method of claim 17, further comprising increasing ionic conductivity of the amorphous polymer by increasing an amount of the high-entropy oxide particles mixed into the slurry.

19. The method of claim 17, wherein the step of drying is performed under a vacuum to remove the solvent.

20. The method of claim 17, wherein the step of forming comprises casting the slurry into the desired shape.
